(19) United States
(12) Patent Application Publication
(10) Pub. No.: US 2020/0334602 A1
(43) Pub. Date: Oct. 22, 2020

(54) SYSTEM AND METHOD FOR MULTILATERAL SCHEDULING OF RESOURCES

(71) Applicant: Elativity, Inc., Midlothian, VA (US)

(72) Inventor: Duane E. Anderson, Midlothian, VA (US)

(21) Appl. No.: 16/387,039

(22) Filed: Apr. 17, 2019

(51) Int. Cl. G06Q 10/06; G06Q 10/10

(52) U.S. Cl. CPC G06Q 10/06314; G06Q 10/1053

(57) ABSTRACT

A computerized multilateral scheduling method and system includes determining availability data for a first resource using first resource calendar data and associating the first resource with a first organization and a second organization, each organization having a manager. The method and system includes receiving first schedule data from the first manager, the first schedule data designating engagement of the first resource at times based on the availability data and updating the first resource calendar data based on the first schedule data. The method and system further includes via a second networked computer, receiving second schedule data from the second manager, the second schedule data designating engagement of the first resource at times based on the availability data and the first schedule data. The method and system updates the first resource calendar data based on the second schedule data and provides the first resource calendar data to the first resource.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to a resource management system and method, more specifically for effectively scheduling resources, such as employees, for multiple engagements with multiple organizations, such as employers.

### BACKGROUND

Within the broadest range of businesses and organizations, there is a need for scheduling resources, such as employees, for performing required duties. Prior techniques for scheduling employees consist of managing different employee availabilities, but those schedule managements are unitary to the business or organization. The prior art is that each business/organization entity uses a process that is separate and isolated from other entities' processes.

Recent economic trends provide that many workers are underemployed, working multiple jobs. This is problematic under the current scheduling techniques because multiple employers are attempting to juggle the essential task of scheduling employees. Problems arise in multiple employers scheduling the shared employee for overlapping times, requiring the employee to change shifts with other works, or the employer having to rework the weekly schedule.

In times of low unemployment, there is also a need for improved resources for candidate and employer evaluation. In-demand employees may consider changing jobs, or growing companies need to expand its numbers of workers. There is a continuing need for availability of resources for evaluating candidates and prospective employers, allowing for more selective entering into employment arrangements.

Given the prior art isolated arrangement of each entities' process, coordination of shared resources must pass manually through a sequence of parties: supervisor A to employee B to supervisor C to employee B to supervisor A, and iterating until a solution is found. Even with efficient personal communications tools, this sequence is cumbersome for all involved parties and often results in the parties opting out of the process and eliminating the sharing of resources as a component of the overall process. If work schedules are not highly predictable for future cycles, the employee may be unable to work or participate with multiple business entities.

The prior art provides calendar sharing tools which may substantially ease the manual coordination process for some subset of entity types and resource roles. However, calendar sharing does not well serve many aspects of the desired process needs for many resources and entities. Example shortcomings: pre-existing calendar-to-calendar incompatibilities, insufficiently rudimentary calendar data structures and workflow do not support dynamic schedule making, there is little assurance of information security for all parties involved, and there may be unanticipated onboarding configuration effort for each new resource.

Therefore, there exists a need for a technical solution allowing for multilateral coordination between organizations for simplifying resource scheduling.

### BRIEF DESCRIPTION

A system and method provides for a computerized multilateral scheduling method and system. The method and system includes determining a person's availability using calendar data. Via a computer processing system, the person is associated with different employers. Based on this association, the calendar data is then available for electronic schedule making by the different employers.

Each employer, typically via a scheduling manager, interacts with the processing system for reviewing availability data and scheduling the person for work. Through the computer processing system, as different employers schedule the person, these times then are noted as being unavailable for other employers.

The method and system, via the computer processing system, across a networked connection manages the person's availability for working scheduled hours for multiple employers. These employers can directly track availability data and manage scheduling decisions, avoiding schedule conflicts. Moreover, the processing system actively tracks employment data, available for varying degrees of tracking performance, pay, or any other employment metric.

In more technical terms, the method and system provides for determining availability for a first resource, where the resource is the person seeking employment or otherwise being engaged. The availability is noted in calendar data, stored in a calendar data database. The processing system associates the first resource with a first organization and a second organization, the first organization having a first manager and the second organization having a second manager. As the resource is associated with various organizations, this calendar data is available to the organizations.

The method and system further includes, via a first networked computer, receiving first schedule data from the first manager, the first schedule data designating engagement of the first resource at times based on the availability data and updating the first resource calendar data based on the first schedule data, including storing the updated first resource calendar data in the calendar data database. Therein, the method and system further includes, via a second networked computer, receiving second schedule data from the second manager, the second schedule data designating engagement of the first resource at times based on the availability data and first schedule data.

The method and system updates the first resource calendar data based on the second schedule data and provides, via a wireless communication network, the first resource calendar data to the first resource via a user interface disposed in a mobile computing device. As such, the method and system provides a technical solution of networked communication between a server and client devices for managing and publishing employee schedules.

The system and method further includes receiving contact information associated with the first resource and storing the contact information in a resource profile database. Therein, the method and system may electronically communicate with the first resource regarding the first resource calendar data, including updating a client-side calendar of the first resource with the first resource calendar data after receipt of the first schedule data and the second schedule data.

The system and method further includes receiving qualification information regarding the first resource and electronically storing the qualification information in a resource profile database. The method and system therein compares the qualification information with a plurality of job listings, the job listings including job qualification factors; and for the job listings where the first resource qualification information matches the job qualification factors, notifies the first resource about the job listings.

The system and method further includes providing a platform for exchanging shifts. The method and system includes receiving a shift transfer request from the first resource and publishing the request for viewing by at least a second resource. The system and method is operative to receive a shift transfer confirmation from the second resource and update the first resource calendar.

The system and method further includes determining availability data for a second resource using second resource calendar data stored in the network-based calendar data database and associating the second resource with the second organization and a third organization, the third organization having a third manager. The method and system, via the second networked computer, receives the second schedule data from the second manager, the second schedule data designating engagement of the second resource at times based on the availability data of the second resource and updates the second resource calendar data based on the second schedule data. The method and system, via a third networked computer, receives third schedule data from the third manager, the third schedule data designating engagement of the second resource at times based on the availability data and second schedule data. Therein, the method and system provides for updating the second resource calendar data based on the third schedule data and providing the second resource calendar data to the second resource, the second organization and the third organization via a plurality of networked user interfaces.

The invention makes it easy for the resource to bind with each employer, and the resource is intrinsically motivated to bind with multiple other employers, if they exist. The viral spread of the tool from employer to employee to other-employers is a key aspect that contributes to the greater utility of the invention. The greater the extent of employees using the tool, the greater the utility to the employer.

The critical advantage over prior art is that this invention significantly reduces the impediments that previously made it so difficult for some parties to participate in sharing resources. Furthermore, this invention provides entirely new conventions for developing/training resources and for discovering new entities/resources. The prior art used isolated separate processes for these latter functions, whereas the invention makes these functions implicit and a collateral organic outgrowth of the process of using the invention for planning.

### BRIEF DESCRIPTION OF THE DRAWINGS

FIG. 1 illustrates one embodiment of a system for computerized multilateral scheduling.

FIG. 2 illustrates a further embodiment of the system for computerized multilateral scheduling as utilized by an employee.

FIGS. 3-6 illustrate sample user interface screenshots for establishing a resource account and engaging with an organization for scheduling;

FIG. 7 illustrates a further embodiment of the system for computerized multilateral scheduling as utilized by a manager.

FIGS. 8-9 illustrate sample user interface screenshots for organizational scheduling operations.

FIG. 10 illustrates a graphical representation of one embodiment of API interactions supporting the present method and system.

FIG. 11 illustrates a flowchart of the steps of a method for computerized multilateral scheduling.

FIG. 12 illustrates an operational timeline for connectivity of resources and managers.

FIG. 13 illustrates a block diagram showing the interactivity for a single resource managing scheduling with multiple managers.

A better understanding of the disclosed technology will be obtained from the following detailed description of the preferred embodiments taken in conjunction with the drawings and the attached claims.

### DETAILED DESCRIPTION

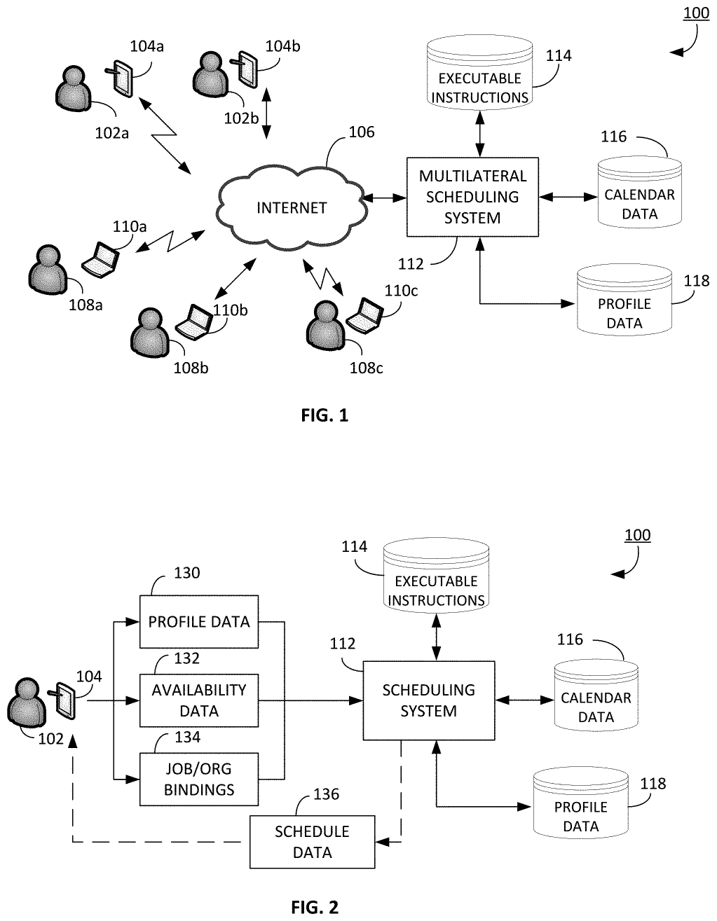

FIG. 1 illustrates a system 100 including a plurality of resources 102, having mobile computing devices 104 accessing a computer network 106. The system 100 further includes a plurality of managers 108 with computing devices 110 also accessing the network 106.

The system 100 includes a multilateral scheduling system 112 with at least three data storage devices. A first data storage device stores executable instructions 114. A calendar data database 116 stores calendar data and a profile data database 118 stored profile data.

The resources 102 in FIG. 1 are illustrated as two different users, but it is recognized that the system operates with any number of users. The users 102 are also referred herein as resources, where in this embodiment users are individuals under the employment or engagement of services or time with an employer, organization, group, etc. In one example, the user 102 may be an employee who works part-time for two different companies, whereby the multilateral scheduling system 112 provides for improved efficiency in scheduling work hours between two or more different companies.

The mobile device 104 may be any suitable mobile computing device usable for accessing the network 106, as well as interfacing with the system 112. In one embodiment, the mobile device 104 is a smart phone with a locally-executing application. In another embodiment, the mobile device 104 may be a laptop or desktop computer, allowing the user 102 to access the system 112 through an application, via a web browser or other computing means.

The manager 108 may be any suitable type of individual or group of individuals that manages or otherwise schedules employees or resources for an organization. In the example of employment, the manager may be an assistant manager tasked with generating employee schedules. In the example of volunteer or philanthropic matters, the manager may be a volunteer coordinator charged with insuring volunteer coverage for specific times. Like the mobile device 104, the computing device 110 may be any suitable device operative to engage the network 106 and perform scheduling operations as described herein.

The multilateral scheduling system 112 includes at least one processing device operative to perform processing operations as described herein. The processing device 112 performs operations in response to executable instructions from storage device 114. The processing device 112 performs these operations in response to inputs received across the network 106, as well as data from the storage devices 116, 118. The processing device 112 further provides output data back across the network 106, as well as storing data in the storage devices 116, 118 as described herein.

The data storage devices 114, 116 and 118 may be any number of data storage devices, located internal to the system 112 and/or in a distributed storage manner, such as across a networked connection. The data storage devices 114, 116 and 118 operate in accordance with known data storage techniques for writing and storing data therein, as well as allowing access to the data for processing operations by the system 112.

In the system 100, the multilateral scheduling system 112 operates to manage scheduling functionalities for the managers 108 by generating schedules for the users 102 based on one or more of: input from the users 102 via the computing devices 104; calendar data from the database 116; and profile data from the database 118. As described in further detail below, through the central platform 112, multiple managers 108 are able to multilaterally schedule users 102.

FIG. 2 illustrates one embodiment of the system 100 with operations directed towards the user 102 with mobile device 104. The system 100 includes the scheduling system 112, with databases 114, 116 and 118. The user 102 additionally generates profile data 130, availability data 132 and job/organization bindings 134. Using processing techniques described herein, the scheduling system 112 generates schedule data 136.

In the embodiment of FIG. 2, the profile data 130 is data representing profile information of the user 108. By way of example, but not limiting in nature, the profile data may include contact information, educational qualifications, work history, current job information, salary information, friends and connections information, and aspirational employment information.

In the embodiment of FIG. 2, the availability data 132 is data representing the availability of the user 108. This data 132 may be times when the user is available and/or times when the user is unavailable. For example, if the user 108 is taking classes and has an established class schedule, the times of those class can be designated as unavailable times. For example, if the user 102 has designated weekend hours as available for engagement, those hours may be designated as available. Further embodiments may include preferred and prioritized availability, for example if one job offers a high pay at preferred times, this time slots can be given a higher priority, e.g. waiting tables during a dinner services can be designated as priority over a straight-wage job working a cash register.

In multilateral scheduling, availability time may also be dictated by managers defining pre-designated time slots versus fillable time slots. For example, for a first job the user may be scheduled two recurring shifts and then up for two shifts at varying times depending on availability. Similarly, multilateral schedule does not require the scheduling parties be different organizations, rather these manages can be different departments or managers within the same organization.

The job/organization binding data 134 is data designating one or more organizations to which the user 102 is associated. As described in further detail below, through binding an organization the user 102 then grants managers of the bound organizations access to data for performing the scheduling operations.

In the embodiment of the FIG. 2, the user 102 submits this information 130, 132 and 134 via an interface operating on the mobile device 104. This data may be generated via the interface on the mobile device 104 or may be accessed via the databases 116 and 118. For example, the user may enter the profile data 130 a first time, and thereafter the profile data is accessed by the scheduling system 112 from the profile data database 118. Similarly, the availability data may be stored in with the calendar data of database 116 or with the profile data 130, whereby the user 102 can verify the availability data for a particular scheduling period.

In one embodiment, data sharing and upload operations may be performed using one more application program interfaces (APIs). For example, the user entering schedule or profile data can then be pushed to the network via APIs. Similarly, when connections are made with different organizations, APIs may provide for pushing the data to the remote application.

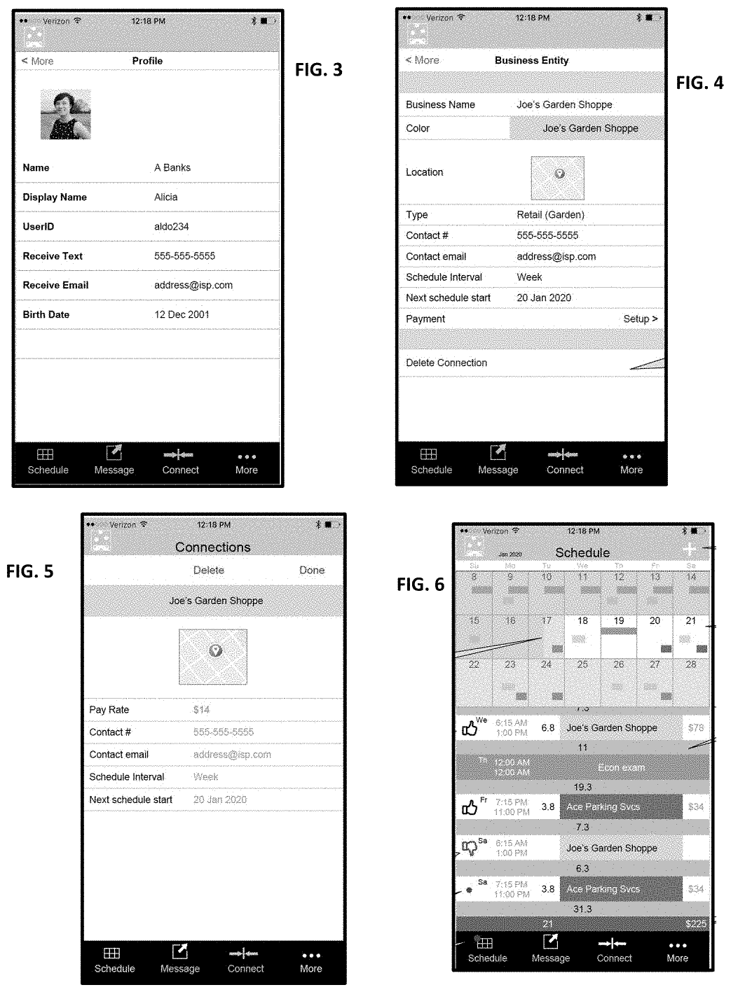

In the system 100, the multilateral scheduling system 112 receives the profile data 130, availability data 132 and binding data 134. As described in further detail below regarding FIG. 3, bound managers then interact with the system 112 to perform scheduling operations.

After scheduling operations are received, the system 112 therein generates schedule data 136. This data 136 is data indicating times in which the user 102 is to be engaged with the employer/organization, as requested by the manager. The schedule data 136 is then made available to the user 102 via the interface on the device 104, such as one embodiment being embedding the schedule data into a calendar application running on the device 104. Another embodiment may be sending notifications to the user's device including a weekly schedule notification, as well as a per-shift reminder notification.

The present system operates across multiple input devices with data managed in a networked environment. One embodiment includes a user interface via a mobile device or desktop computer.

FIG. 3 illustrates one exemplary screen capture of a user interface include a user profile. Where the user interface is an application running on a mobile device, the user interface may include input functionality consistent with known application technology. In FIG. 3, the user interface screen capture shows information for the user, including contact information.

FIG. 4 illustrates one exemplary screen capture for the organization, including profile information about the business. The organization can manage this profile information, as necessary.

FIG. 5 illustrates a screen capture of a connections listing. This screen capture shows that the user is now connected with the business identified in the profile of FIG. 4. While the front-end user interface shows that the user and the organization are now connected, the back-end processing system authorizes data sharing enabling multiple functionalities for scheduling. For example, upon connection, the processing system can then facilitate direct communication between the user and the business. The processing system may allow for financial information, such as tax and citizenship verification, direct deposit payment, etc.

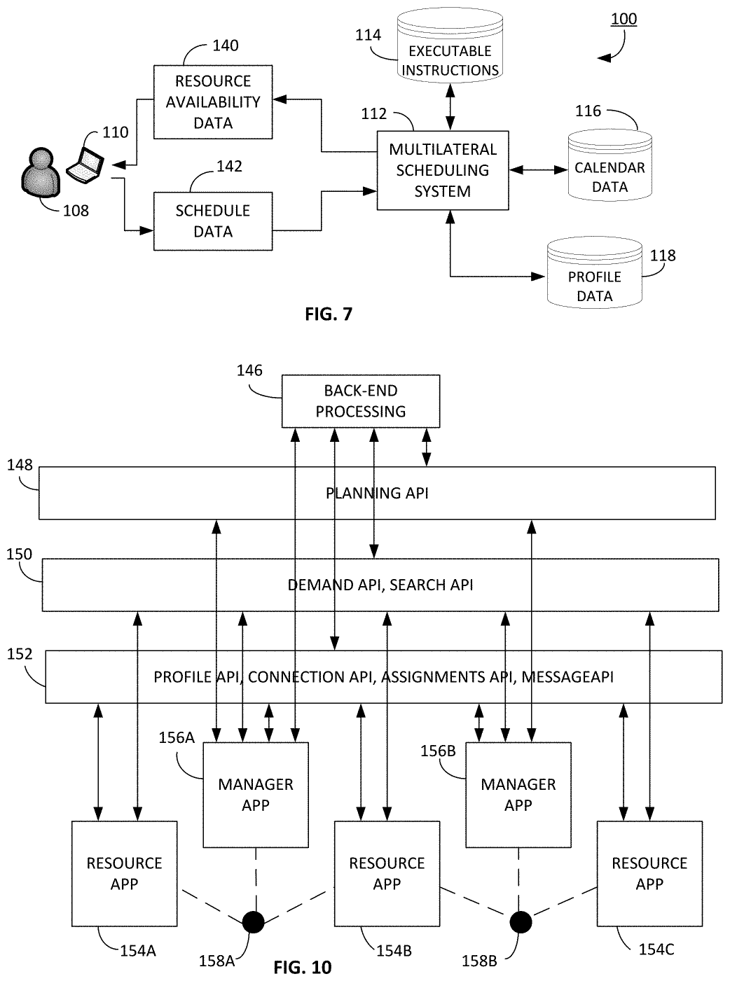

Within the user interface, FIG. 6 illustrates a screen capture of a scheduling interface as noted by the user. The user can be presented with a calendar display and notations of multiple scheduled events, such as work shifts. Where, as described in further detail herein, as one organization performs scheduling operations, availabilities of times are then updated to other connected organizations. For example, the first organization schedules the user for a shift from 4-8 pm on next Tuesday, that same time window is indicated as being unavailable to all other connected organizations.

Whereas FIG. 2 illustrates interactivity from the user 102, FIG. 7 illustrates interactivity from the manager 108. In the system 100, different organizations provide for scheduling users, the organizations provide scheduling via one or more managers. As noted in FIG. 2 above, the user is bound to one or more organizations and hence the managers 108 are therein allowed to access the user data, as well as perform scheduling operations.

In the system of FIG. 7, the multilateral scheduling system 112 provides resource availability data 140 to the manager 108, for display on the computing device 120. The resource availability data 140 is data representing the availability data of the user 102 of FIGS. 1 and 2, also referred herein as a resource.

Via the interface running on the device 120, the manager 108 therein assigns one or more shifts to the user, filling out the calendar for a designated period of time, such as a week, two weeks, month, etc. The interface 120 collates this data and returns it to the multilateral scheduling system 112 as schedule data 142. Thereby, the scheduling system 112 updates the calendar data 116 based on the schedule data 142.

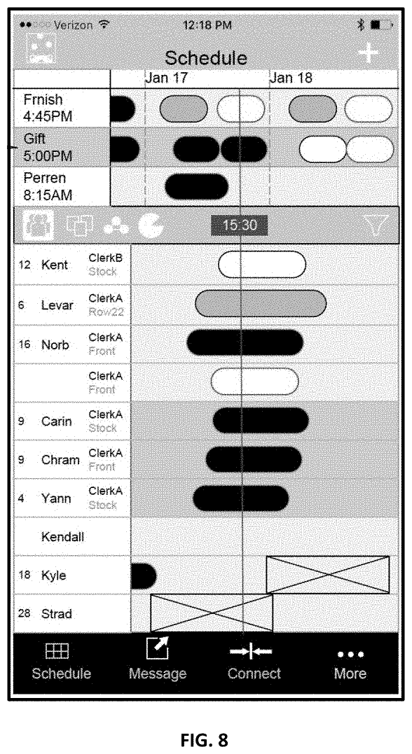

FIG. 8 illustrates a sample screen capture for the scheduling user interface. This interface, operative via any suitable computing device, allows for managing scheduling operations for multiple users, each of these users potentially having varying degrees of availability.

In this sample screenshot, the manager views scheduling at 15:30 hours on January 17. The schedule includes three departments on top and available employees below. Here, the exemplary department is giftware, needing seven spots filled: three stocker positions, three front positions, and an onsite attendant. For these positions, the user interface indicates various employees who are available for scheduling.

The data available on the user interface is processed by the scheduling system. For example, in the interface two potential employees are noted as not being available for the full shift because their pre-existing schedule data indicates unavailability. The interface may include shading to represent an offer to work for one or more employees, awaiting confirmation from the employee. Whereas dark coloring may indicate confirmation of scheduling or assignment of shift.

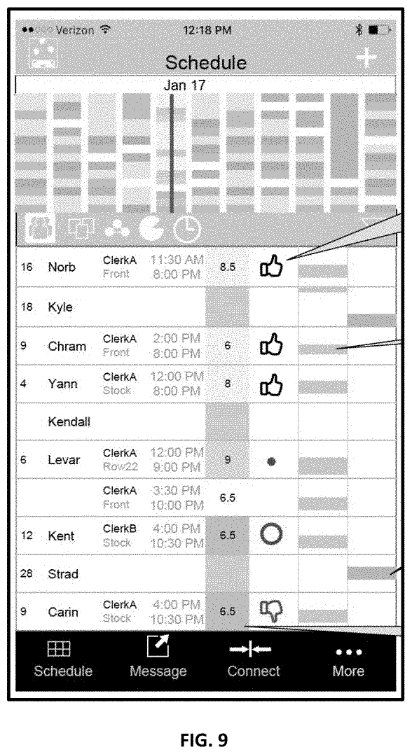

FIG. 9 illustrates another exemplary screenshot for a user interface for scheduling data. This user interface can include color-coded shading for indicating availability for different users. As the manager assigns the shift to the user, employee, via the user interface, the user can then be notified.

Referring back to FIG. 2, the system 112 may then distribute the schedule data 136 back to the user 102 via the mobile device 104. The user 102 can then view an updated schedule, e.g. FIG. 6 that includes the new assignment. In one embodiment, if the user is requested to work a shift, the notification may include a request message for the user to confirm the schedule assignment. Whereas, other embodiments can include simply notifying the employee they are to report to work at the designated time.

Where the above FIG. 2 and FIG. 7 discussion relates to a single user 102 and a single manager 108, the multilateral scheduling operations provide for more than one manager 108. Therefore, the system of FIG. 7 operates with different managers 108, the variance being the resource availability data 140.

If the user is bound to two organizations, hence two different managers, the first manager receives the resource availability data without second manager input. The second manager receives resource availability including the schedule data of the first manager. It is noted, the term organization may be different companies or entities, but may also be different departments or sections within the same organization.

Using the example, a first resource is bound to organizations 1 and 2 and a second resource is bound to organizations 2 and 3. Thus, organization 2 seeks to schedule the first and second resource, but availability can fluctuate based on scheduling operations of organization 1 and organization 3.

Therefore, when organization 2 sets a schedule for resources 1 and 2, the method and system updates scheduling data for organization 1 relative to resource 1 and scheduling data for organization 3 relative to resource 2. Similarly, when organization 1 sets a schedule for resource 1, resource 1 schedule data is updated for organization 2 and when organization 3 sets a schedule for resource 2, resource 2 schedule data is updated for organization 2.

Further embodiments provide for managers to designate prospective times for work shifts, listing them as unavailable if even if the manager has not yet expressly conducted the scheduling operations. For example, if the user is the only person qualified to work a particular shift for the first organization and the first manager has not yet completed scheduling operations, that shift may be reserved by being marked as unavailable.

Where the present method and system is performed using processing operations in a processing environment, FIG. 10 illustrates a graphical representation of one embodiment an API structure for managing multiple scheduling operations.

FIG. 10 illustrates one exemplary embodiment including a back-end processing module 146. In one embodiment, this may be executed on a server or other networked environment. A first layer 148 includes a planning API. The planning API includes functionality for managers to set up scheduling operations and manage staffing levels.

A second layer 150 includes a demand API and a search API. The demand API provides functionality for enabling swapping or changing of assigned shifts. The search API provides functionality for conducting electronic searching, such as a resource, e.g. employee, volunteer, etc., conducting a search for a new employer or other type of organization. Another type of search may be for an organization to conduct searches for new resources, e.g. employees.

A third layer 152 includes multiple APIs such as a profile API, a connection API, an assignments API, and a message API.

The profile API provides functionality for profile services, which is a core service that is used to store identifier data about each user (e.g. resource, manager, organization). The profile can include user's general preferences for the method and system, as well as general preferences related to connected or bound business entities, managers. In one embodiment, performance scores that are subjectivity derived from user assessments are also maintained as part of the profile API.

The connection API provides functionality relating to services for the four logical role types that are leveraged in all other services and provide universality of the system. The four logical role types are resource, manager, binder, and business entity. Via functionality enabled by the connection API, the method and system creates, validates, and maintains connections between user and between users and logical Business Entities and their organization sub units, herein referred to as binders. Connections allow for access and scope of interconnectivity and the logical conduits for assigning resources and viewing availability.

The connection API includes functionality such as managing requests, authentications and confirmations of new connections. The connection API further includes functionality to manage existing connections, including for example deleting connections, moving connections to different business entities, view connection data and manage attribute data.

The assignment API provides functionality for users to view and make assignments, as well as designating non-availability. For example, a manager may use the assignment API to set schedules for bound resources and the resource can use the assignment API to designate blocks of time as unavailable for scheduling. Each application that represents a resource can have full visibility to their assignments, including one option to accept or decline an assignment. In one embodiment, resources may also view assignments of co-workers.

The messaging API provides functionality for sending messages between users. For example, a resource may contact a manager by creating a message via the messaging API and the manager receiving the message via the messaging API.

In the system of FIG. 10, multiple applications access the API layers 148, 150, and 152. A resource application 154 represents functionality by the resource for receiving scheduling information. A manager application 156 represents functionality by the manager for generating schedules. Illustrated in FIG. 10 are three resources, 154A-154C and two managers 156A-156B, where it is recognized that any number of resources and managers operate using the present method and system.

Moreover, the connection points 158A and 158B of FIG. 10 represent external connectivity between manager app 156 and resource app 154. For example, one embodiment may include a QR code or any other type of image displayable on a manager app, the resource app capturing the image to create bindings. Another example may be a Bluetooth connection or other type of direct connectivity verifying proximity and bindings between apps.

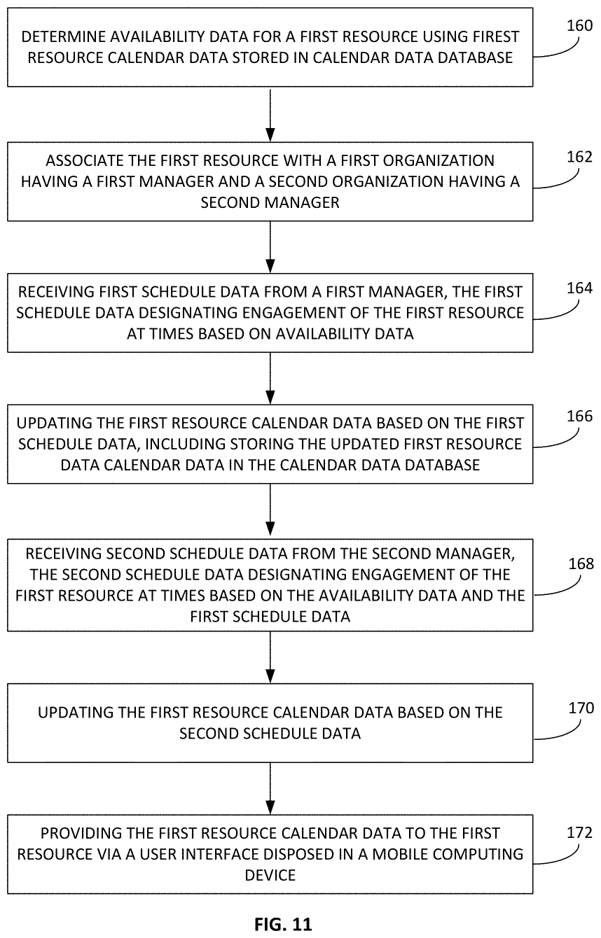

FIG. 11 illustrates a flowchart of one embodiment of a methodology for multilateral scheduling. The methodology may be performed using the system 100 of FIG. 1 as described above. This embodiment provides for a single user/resource accessing scheduling information from two organizations/managers.

A first step, step 160, is determining availability data for a first resource using first resource calendar data stored in a network-based calendar data database. In the system 100 of FIG. 1, the calendar data is stored in the database 116, which may be pre-existing data or can be pre-existing data in collaboration with any new availability data 132 of FIG. 2.

A second step, step 162, is associating the first resource with a first organization and a second organization, the first organization having a first manager and the second organization having a second manager. The system 112 of FIG. 1 binds the user/resource based on profile data stored in the database 118.

A next step, step 164, is via a first networked computer, receiving first schedule data from the first manager, the first schedule data designating engagement of the first resource at times based on the availability data. A further step, step 166 is updating the first resource calendar data based on the first schedule data, including storing the updated first resource calendar data in the calendar data database. As described above, these steps may be performed using the system of FIG. 3.

Where the user has scheduling data for a first organization, the multilateral scheduling system accounts for a second organization, granting the second organization rights to schedule. Therefore, a next step, step 168 is via a second networked computer, receiving second schedule data from the second manager, the second schedule data designating engagement of the first resource at times based on the availability data and first schedule data.

Step 170 is updating the first resource calendar data based on the second schedule data. Therein, step 172 is providing, via a wireless communication network, the first resource calendar data to the first resource via a user interface disposed in a mobile computing device. Therefore, in this methodology, the single user has scheduling performed via a single system for multiple organizations, the unified schedule then electronically distributed to all parties.

While described above using the example of a single user having two bound organizations, the system and methodology operates with any number of users and any number of bound organizations. The multilateral scheduling system 112 operates to manage and facilitate scheduling for any number of parties through the central network-accessible platform.

As part of the operations, the method and system operates using a connections data model. These connections provide for interactivity and data management between users, including between connected managers and between managers and connected resources.

As used herein, a binder is the grouping of Resources (and implicitly their assignments) that are connected to that binder, under the direction of connected Managers. Managers connected to the binder perform functions that are directed, by default, at resources within that binder. Each binder has one parent, and 0 or more child Binders. A Binder defines the scope of visible resources, managers, for users connected to that Binder. Sub-binders are visible to Managers.

Typically, a Binder encapsulates a workforce that is scheduled by one manager, plus that manager's co-managers. In one embodiment, he usability of the system by the manager is tuned to bias convenience for the directly-connected manager.

Each resource is connectable to zero to any number of business entities. A business entity refers to an organization, business, or other unit of management for engaging in scheduling operations. For each resource connection to a business entity, there is at least one connection to a binder, whereas there are my zero or more connections to a manager.

For a manager, as used herein, is an account or data entry point associated with a person or position for scheduling operations. The manager represents the person in charge of scheduling or otherwise performing schedule, which may be schedule for the business entity. Each manager is connected to zero or one business entity and connected to one binder per business entity. Each manager is connected to each resource that is connected to the binder and to each resource that is connected to any child binders.

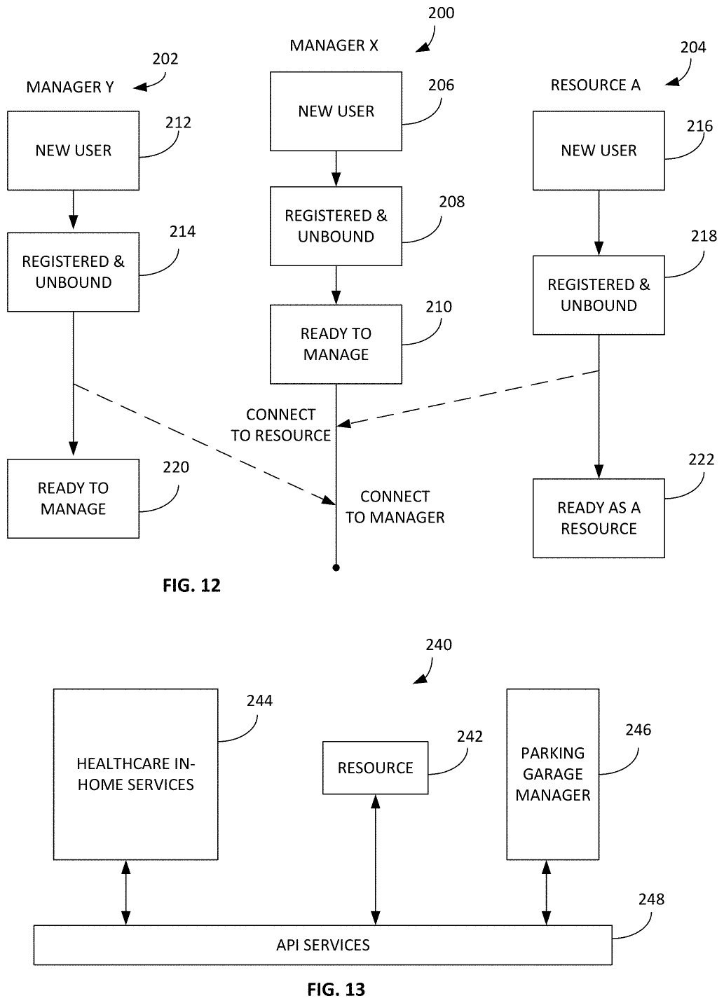

FIG. 12 illustrates a flow diagram representing embodiment for connectivity between different users. Here, the users are Manager X 200, Manager Y 202 and Resource A 204. Manager X 200 and Manager Y may be within the same business entity, such as different departments of the same company.

In terms of operations, executable using APIs as noted above, the manager 200 enters as a new user 206, and performs registration operations 208, being unbound, which including not being bound to any resources or other managers. In this example, the manager 200 may be the first manager for a business entity, the business entity being a hardware store with multiple departments, the manager 200 managing a first department. Upon registration, the manager 200 is ready to perform management operations 210. The manager 200 as the first user for the business entity may also set-up the business entity within the processing system.

Separately, manager Y 202 enters a new user 212, which may including download the application or creating an online portal. In step 214, manager Y 202 registers and is initially unbound. Similarly, at a separate time, resource A 204 enters as a new user 216 and registers 218, being unbound.

Resource A 204 seeks a binding with Manager X 200, for example if Resource A 204 was just hired by Manager X. Therefore, a connection operation connects Resource A 204 to Manager X 200.

Manager Y 202 seeks a connection with Manager X 200, for example if Manager Y works for the same business entity as Manager X 200, but a different department. Therefore, a connection operation connect Manager Y 202 to Manager X 200.

Now, all three users 200-204 have bindings. Manager Y 202 can now proceed with management operations 220, using APIs as described herein and Resource A 204 can proceed with using the method and system as a resource 222 using APIs as described herein.

FIG. 13 illustrates a generalized diagram showing one embodiment of multiple business entities providing scheduling operations. The system 240 includes a first resource 242 here being bound to a first manager being a healthcare in-home services entity 244 and a second manager being a parking garage manager 246. The system 240 provides scheduling services via the application services 248.

The resource 242 is bound to the managers 244, 246 using binding operations noted herein. By being bound, the resource 242 authorizes sharing calendar information. The resource 242 may communicate with the managers 244, 246, as well as view scheduling information generated by the managers 244, 246.

For example, the parking garage manager 246 may generate a weekly schedule for the resource, considering any unavailable times, any preferred times, and other calendar data. As garage manager 246 schedules the resource 242, the healthcare manager 244 can be notified of changes in availability for the resource 242. These scheduling operations may include tentative assignments, subject to resource approval.

The system 240 of FIG. 13 illustrates a high level overview of how the multiple managers 244, 246 interact with a single resource 242 via the application services layer 248, which in one embodiment operates on a network or cloud-based processing environment.

Further embodiments include additional operations congruent with the above described method and system. For example, profile information for the users may additionally include contact information. The contact information may be, for example, home address and phone numbers, mobile phone number(s), email and other electronic communication means, and social media account information. The scheduling system 112 therein may use the contact information for allowing varying forms of notification of scheduling information.

In addition to using the contact information for schedule distribution, the scheduling system 112 may also utilize the contact information for communication between users and/or managers. For example, it is not uncommon for users to need coverage for a particular shift, or swap shifts, based on unexpected events. Therefore, one embodiment of the system 112 includes a bulletin board or other communication means for posting wanted or available shifts. Users can communicate directly through the system 112 or via other communication means as indicated by the profile data having contact information. For example, user profile data can indicate that a user prefers to be contacted via text message to a mobile phone number. Therefore, the system 112 can automatically set the notifications for changing shifts via text message. In one embodiment, communications outside the system 112, e.g. via an email or text message, can include an active link for engaging an action back within the system 112.

In the system 112, if a shift transfer request is agreed upon, the system 112 updates calendar information and distributes updating information to particular parties. For example, the calendar information may be updated for both users swapping shifts and for the manager and/or organization associated with the users. In one embodiment, the shift transfer may require supervisor approval, therefore the system 112 can create an intervening step for manager approval before formalizing the calendar changes.

The system 112 may additionally provide a central job posting platform. The profile data in the database 118 may include job qualification information including work experience information, educational background, job training and functions, references, among other information. Via the system, users 102 may then conduct searches for new employment or engagement opportunities. Any application process can be significantly improved and streamlined with the user's profile information already apart of the system. Therefore, users can submit full applications with a single click of a button, avoiding the repetitive process of filing out job applications.

Where the job listing benefits the users 102, the system 112 also provides improve candidate searching opportunities for managers and organizations. Where the profile data includes job qualification information regarding the multiple resources, candidate searching operations can be performed using a database access operation. Therefore, managers can search for possible new employees by simply accessing the profile data database 118 for users 102 matching the job listing qualifications. Then, via the contact information in the profile data, employers may then seek to contact the candidates for interest in the new position.

The work experience information for a user may also include work performance data. For example, performance data may include objectively calculated rating based on measurements, such as: declined assignments, lateness of declined assignments, on-time shift starts, flexibility for accepting late schedule changes, and subject ratings may include on-time information indicating how often a user is late for work or willing to stay late on a shift, prior work experience information including performance review information, as well as general availability data indicating the degree to which the user is generally available for a variety of different shifts. Varying embodiments may include object performance data and/or subject performance data such as performance reviews, etc.

In one embodiment, this work performance data may be stored in a database and associated with the user's profile. For privacy reasons, the data may be access restricted to the manager or organization submitting the information and the user. Whereby, if the user applies for a position, the hiring manager may then be granted temporary access to the performance data for job qualification assessment.

Moreover, as described herein, the resource may be any resource or other element having associations or bindings with multiple organizations. For example, the above embodiments describe the resource as a single individual, such as an employee or volunteer. Another embodiment includes the resource as a team of individuals, for example a consulting team working on multiple consulting projects where the team itself is scheduled. Another embodiment includes the resource as a piece of equipment, such as specialized equipment shared between different organizations or different individuals, for example a chemical testing device used by multiple professionals.

Resources (e.g. employees) use a computer program to view and interact with their schedules, availability, skills, attendance records, performance ratings, and discovery of new employment positions opportunities. Entities (e.g. employer supervisors) use a computer program to view and interact with each resource's schedules, availability, skills, attendance records, performance ratings, costs, and discovery of potential new qualified employees. Each respective computer program communicates with a central system that houses a central database of data for each entity and resource, and performs processing on the central data per the requests of each resource or entity.

The binding of each particular resource to each particular chosen entity establishes relationships that are fundamental to the operation of the functions of the invention. This binding design creates a relationship pattern between parties which is intrinsically classified as many-to-many, whereas the prior art is intrinsically classified as one-to-many. In addition to the vertically oriented bindings (i.e. employee-to-employer), the invention also provides for horizontal bindings between coworkers and between supervisors, and for binding inheritance in the case of shared duties between supervisors.

The resource user (e.g. employee) computer program performs functions in conjunction with the central components of the system. The employee resource user uses the computer program to configure their profile, which may include information that they desire to share with bound entities. The resource user uses the computer program to view information about each bound employer supervisor entity. The resource user uses the computer program to initiate, acknowledge, or delete bindings with an employer supervisor entity.

Similarly, where an employer is not on the processing platform or not otherwise bound to the user, the user may use the computer program with dedicated private virtual entities as a means to create a substation for entities that do not participate in the system. The user can manually provide schedule information for the virtual entity, so the resource's availability data is accurate.

The employee uses the computer program to schedule time (recurring and nonrecurring) that they are (or are not) available to work for each entity, or every entity. The employee uses the computer program to view past and future work schedules provided by each bound entity. The employee uses the computer program to acknowledge future work schedules provided by each bound entity.

The work schedule may be communicated to a separate calendar system accessed by the same computer device that is executing the resource user computer program. The resource user uses the computer program to set times required for breaks between job shifts. The resource user uses the computer program to set times required for traveling between job shifts. The resource user uses the computer program to set constraints per each entity that they are bound to. The resource user uses the computer program to establish preferences or priorities between or amongst each entity that they are bound to.

The resource user uses the computer program to reserve time on the schedule that is specifically reserved for one, or more, but not necessarily all bound entities. The reserved time may be configured by the resource to become unreserved upon the event of certain combinations of triggers, which are set by the resource, such as: time, number of hours planned, date, etc. In one embodiment, this may be referred to as hyper-availability, where the user is not directly assigned a time, but the schedule indicates a willingness or preference for scheduling at the designated time. In one embodiment, hyper-availability may be used to designate on-demand or on-call availability for users, such as being scheduled or available with extremely short notice.

The resource user's computer program implements either geo-fencing or an acknowledgement of hours worked to keep track of approximate hours worked each week per employer. The resource user may use the resource user's computer program to view reports based upon week/month/year.

The resource user uses the computer program to advertise willingness to trade an assigned shift. The advertisement includes suggested other resource parties, time slots available, expiration conditions, etc. The resource user uses the computer program to view compatible shift trade advertisements, to accept or decline offers, to set conditions of acceptance, and to view and acknowledge completed trades.

The resource user uses the computer program to send messages to the employer about concerns or events such as lateness, sickness, etc. The resource user uses the computer program to receive messages, and alternately configure the central system to send email or text alerts for upcoming shifts or shift changes. The resource user uses the computer program to view messages of specific interest or general interest that are sent by the employer supervisor entity.

The resource user uses the computer program to view and suggest the list of skills that the employee possesses. The resource user uses the computer program to view the list of skills expected or needed by the employer entity. The resource user uses the computer program to indicate or select the desired set(s) of skills that the employee seeks to be trained.

The resource user uses the computer program to subjectively rate each employer supervisor entity. The resource user uses the computer program to view a objective rating, assigned to each employer supervisor entity. This rating is a weighted sum, or other type of scoring, of several factors which may include: number of hours per week that are scheduled per employee, late employer schedule changes, and under/over hours worked relative to the plan.

The resource user uses the computer program to view the ratings of the employer supervisor entity in comparison to other employer supervisor entities based upon geography, industry, skills scope, size, etc. The resource user uses the computer program to view the rating of the resource as set by each employer supervisor entity. The resource user uses the computer program to view the rating of the resource as calculated by the central system per employer supervisor entity based upon weighted factors such as: on-time shift starts, # of requests to change the schedule, no-shows. The resource user uses the computer program to view the ratings of the resource in comparison to other resources based upon geography, industry, skills, etc.

The resource user uses the computer program to view job positions that may be solicited to resources that have the attributes desired by the seeking employers, from employers that have the attributes desired by the employee. Attributes may include quantitative and subjective ratings, industry categories, skill sets, geography, schedule compatibility, etc. The resource user uses the computer program to indicate if they are interested in advertising their availability to receive new offers of employment. Attributes of qualified recipient viewers of the resources availability may be set by attributes which may include quantitative and subjective ratings, industry categories, skill sets, geography, schedule compatibility, etc.

The resource user uses the computer program to view and respond to unsolicited messages that may be of relevant interest to the user, that are provided by the invention.

The employer supervisor entity (e.g. employer) computer program performs functions in conjunction with the central components of the system. The employer supervisor entity user uses the computer program to initiate, acknowledge, or delete bindings with an employee resource or an employer supervisor entity. The employer supervisor entity user uses the computer program to configure their profile which may include information that they desire to share with bound entities. This information may include, but is not limited to: business name, location, and industry category. The employer supervisor entity user uses the computer program to view information about each bound employee resource.

The employer supervisor entity uses the computer program to assign employee resources work at specific times. The employer supervisor entity uses the computer program to view available times for each employee resource. The employer supervisor entity uses the computer program to indicate the assignment(s) for each shift. For example, stock room, floor, reception.

The employer supervisor entity uses the computer program to create and save staffing need templates. The employer supervisor entity uses the computer program to create and save shift assignment plan templates. The employer supervisor entity uses the computer program to activate an automatic scheduling feature which finds a solution for mapping resources to work times given a variety of constraints such as availability, skills, upper/lower limits on hours per various type of work cycle, and other constraints. The employer supervisor entity uses the computer program to approve shift swaps, and to set conditions for shift swaps.

The employer supervisor entity uses the computer program to message to employees—general announcements, IM, alerts about last minute schedule changes. The employer supervisor entity uses the computer program to receive email or text alerts.

The employer supervisor entity uses the computer program to enter a list of skills that cover the range of needed staff skills The employer supervisor entity uses the computer program to associate skills with specific employees. The employer supervisor entity uses the computer program to make training plan, and to track training outcomes

The employer supervisor entity uses the computer program to subjectively rate each employee resource. The employer supervisor entity uses the computer program to view a rating, assigned to each employee resource, that is computed by the central system. This rating is a weighted sum, or other type of scoring, of several factors which may include: on-time shift starts, # of requests to change the schedule, no-shows. The employer supervisor entity uses the computer program to view the ratings of the employee resource in comparison to other employee resources based upon geography, industry, skills, experience, etc. The employer supervisor entity uses the computer program to view the rating of the employer supervisor entity as set by each employee resource. The employer supervisor entity uses the computer program to view the ratings of the employer supervisor entity in comparison to other employer supervisor entity based upon geography, industry, skills, etc.

The employer supervisor entity uses the computer program to view reports per employee. Reports may include exception, hours worked, costs etc. The employer supervisor entity uses the computer program to view reports for shifts, and teams.

The employer supervisor entity uses the computer program to advertise open positions to employee users based upon geo and schedule. The employer supervisor entity uses the computer program to set the minimum attributes for who may see the opening. This is designed to assist the supervisor in finding the best new hires. Attributes may include quantitative and subjective ratings, industry categories, skill sets, geography, schedule compatibility, etc.

The employer supervisor entity uses the computer program to view job applicants that have responded to solicitations. to resources that have the attributes desired by the seeking employers, from employers that have the attributes desired by the employee. Attributes may include quantitative and subjective ratings, industry categories, skill sets, geography, schedule compatibility, etc. The employer supervisor entity uses the computer program to search for or to make direct solicitation to resources based upon skills, ratings, availability, geo, industry, etc.

Employees may bid for pay rate bonuses posted by the supervisor. The supervisor sets the terms as a maximum of % of over-regular rate pay. Employees bid by agreeing to accept the schedule at the current incentive level, or they do not agree. With each bid, the incentive auto-decrements, or the bidder manually sets the incentive lower than the auto-decrement. The bidding lasts until the incentive % reaches a supervisor-set floor.

The employer supervisor entity uses the computer program to share employee resources with other employer supervisor entities. The employer supervisor entity uses the computer program to acknowledge sharing employee resources with other employer supervisor entities. Employee resources achieve an inherited binding with supervisors that are bound horizontally by existing bound supervisors. Each member of a supervision team (i.e. horizontally bound employer supervisor entities) is provided with identical functionality.

The employer supervisor entity uses the computer program to view and respond to unsolicited messages that may be of relevant interest to the entity, that are provided by the invention.

In addition to the functionality described above, the method and system includes operations for increasing acceptance and usage of the scheduling system. For example, one embodiment includes an employer or organization subscribing to the scheduling services. The organization may create accounts for existing employees, or have those employees generate accounts on their own.

When a new employee is hired, that employee is then added to the scheduling system. For example, a new hire can download a schedule application during the hiring or orientation process. The employee can generate a bind request that can be sent directly to the new employee. Or in another embodiment, the organization can generate a specialized code or image on the organization's device. The employee can then activate a camera or other scanner to acquire the image. The local-processing application can process the image to recognize the binding request, the requesting organization, and then create the binding via the network processing system.

Once bound, the employee grants the organization access to one or more calendars or calendar data entered into the scheduling application. Using data exchanges and data interfacing as described above, the organization can then seamlessly incorporate the new hire into the scheduling operations.

As the newly hired employee now manages scheduling through the application, the employee is motivated to propose the scheduling application to other organizations. Having multiple organizations now makes the ease of scheduling available not only to those specific organizations, but also for users needing to juggle multiple job schedule requirements.

Similarly, for an organization having multiple departments or scheduling managers, growth may be internal by a first manager conducting electronic scheduling using the present method and system and requesting other managers to also use the system for shared employees. Then, as more managers within an organization utilize the scheduling, it becomes significantly more efficient for the organization as a whole to use the scheduling for all employees.

Where the above method and system provides ease of electronic scheduling for a user with multiple organizations, it is recognized the schedules are not expressly limited to employer/employee relationship. For example, one embodiment may be volunteer work. Another embodiment may be community service events. In general, the system and method allows for a single user to generate an electronic schedule having available and conflict times for one or more parties, reducing complications for generating schedules that can be subject to numerous timing conflicts.

Whereby, as described herein, the present method and system provides for multilateral scheduling for multiple users having engagements or commitments with multiple different organizations through a centralized platform.

FIGS. 1 through 11 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized multilateral scheduling method comprising:
determining availability data for a first resource using first resource calendar data stored in a network-based calendar data database;
associating the first resource with a first organization and a second organization, the first organization having a first manager and the second organization having a second manager;
via a first networked computer, receiving first schedule data from the first manager, the first schedule data designating engagement of the first resource at times based on the availability data;
updating the first resource calendar data based on the first schedule data, including storing the updated first resource calendar data in the calendar data database;
via a second networked computer, receiving second schedule data from the second manager, the second schedule data designating engagement of the first resource at times based on the availability data and the first schedule data;
updating the first resource calendar data based on the second schedule data; and
providing, via a wireless communication network, the first resource calendar data to the first resource via a user interface disposed in a mobile computing device.

2. The computerized scheduling method of claim 1, wherein the first resource is an employee in the employment of the first organization and the second organization.

3. The computerized scheduling method of claim 1 further comprising:
receiving contact information associated with the first resource;
storing the contact information in a resource profile database; and
electronically communicating with the first resource regarding the first resource calendar data, including updating a client-side calendar of the first resource with the first resource calendar data after receipt of the first schedule data and the second schedule data.

4. The computerized scheduling method of claim 1 further comprising:
receiving qualification information regarding the first resource;
electronically storing the qualification information in a resource profile database;
comparing the qualification information with a plurality of job listings, the job listings including job qualification factors; and
for the job listings where the first resource qualification information matches the job qualification factors, notifying the first resource about the job listings.

5. The computerized scheduling method of claim 4 further comprising:
receiving a job application request from the first resource for one or more of the job listings; and
notifying a job listing organization in response to the job application request.

6. The computerized scheduling method of claim 5 further comprising:
receiving performance data relating to the first resource from at least one of the first manager and the second manager;
electronically storing the performance data in the resource profile database, associated with the first resource; and
granting access to the performance to the job listing organization based on the job application request of the first resource.

7. The computerized scheduling method of claim 6, wherein the performance data includes at least one of: on time information; prior experience information; and availability data.

8. The computerized scheduling method of claim 1 further comprising:
receiving a shift transfer request from the first resource;
publishing the shift transfer request for viewing by at least a second resource;
receiving a shift transfer confirmation from the second resource; and
updating the first resource calendar data based on the shift transfer request.

9. The computerized scheduling method of claim 1 further comprising:
determining availability data for a second resource using second resource calendar data stored in the network-based calendar data database;
associating the second resource with the second organization and a third organization, the third organization having a third manager;
via the second networked computer, receiving the second schedule data from the second manager, the second schedule data designating engagement of the second resource at times based on the availability data of the second resource;
updating the second resource calendar data based on the second schedule data;
via a third networked computer, receiving third schedule data from the third manager, the third schedule data designating engagement of the second resource at times based on the availability data and second schedule data;
updating the second resource calendar data based on the third schedule data; and
providing the second resource calendar data to the second resource, the second organization and the third organization via a plurality of networked user interfaces.

10. The computerized scheduling method of claim 1, wherein the resource is at least one of: an employee, a team of employees, and at least one piece of equipment.

11. A system for multilateral schedule comprising:
a data storage device having executable instructions stored therein;
a calendar data database having calendar data stored therein; and
a processing device, in communication with the calendar data database and the profile data database, in response to the executable instructions, operative to:
determine availability data for a first resource using first resource calendar data stored in the calendar data database;
associate the first resource with a first organization and a second organization, the first organization having a first manager and the second organization having a second manager;
via a first networked computer, receive first schedule data from the first manager, the first schedule data designating engagement of the first resource at times based on the availability data;
update the first resource calendar data based on the first schedule data, including storing the updated first resource calendar data in the calendar data database;
via a second networked computer, receive second schedule data from the second manager, the second schedule data designating engagement of the first resource at times based on the availability data and the first schedule data;
update the first resource calendar data based on the second schedule data; and
provide, via a wireless communication network, the first resource calendar data to the first resource via a user interface disposed in a mobile computing device.

12. The scheduling system of claim 11, wherein the first resource is an employee in the employment of the first organization and the second organization.

13. The scheduling system of claim 11, wherein the processing device is further operative to:
receive contact information associated with the first resource;
store the contact information in a resource profile database; and
electronically communicate with the first resource regarding the first resource calendar data, including updating a client-side calendar of the first resource with the first resource calendar data after receipt of the first schedule data and the second schedule data.

14. The scheduling system of claim 11, the processing device further operative to:
receive qualification information regarding the first resource;
electronically store the qualification information in a resource profile database;
compare the qualification information with a plurality of job listings, the job listings including job qualification factors; and
for the job listings where the first resource qualification information matches the job qualification factors, notify the first resource about the job listings.

15. The scheduling system of claim 14, the processing device further operative to:
receive a job application request from the first resource for one or more of the job listings; and
notify a job listing organization in response to the job application request.

16. The scheduling system of claim 15, the processing device further operative to:
receive performance data relating to the first resource from at least one of the first manager and the second manager;
electronically store the performance data in the resource profile database, associated with the first resource; and
grant access to the performance to the job listing organization based on the job application request of the first resource.

17. The scheduling system of claim 16, wherein the performance data includes at least one of: on time information; prior experience information; and availability data.

18. The scheduling system of claim 11, the processing device further operative to:
receive a shift transfer request from the first resource;
publish the shift transfer request for viewing by at least a second resource;
receive a shift transfer confirmation from the second resource; and
update the first resource calendar data based on the shift transfer request.

19. The scheduling system of claim 11, the processing device further operative to:
determine availability data for a second resource using second resource calendar data stored in the network-based calendar data database;
associate the second resource with the second organization and a third organization, the third organization having a third manager;
via the second networked computer, receive the second schedule data from the second manager, the second schedule data designating engagement of the second resource at times based on the availability data of the second resource;
update the second resource calendar data based on the second schedule data;
via a third networked computer, receive third schedule data from the third manager, the third schedule data designating engagement of the second resource at times based on the availability data and second schedule data;
update the second resource calendar data based on the third schedule data; and
provide the second resource calendar data to the second resource, the second organization and the third organization via a plurality of networked user interfaces.

20. The scheduling system of claim 11, wherein the resource is at least one of: an employee, a team of employees, and at least one piece of equipment.
